(19) United States
(12) Patent Application Publication
(10) Pub. No.: US 2025/0361697 A1
(43) Pub. Date: Nov. 27, 2025

(54) METHOD, APPARATUS, AND SYSTEM FOR ESTIMATING COORDINATES OF A BUCKET TOOTH TIP, EXCAVATOR, AND STORAGE MEDIUM

(71) Applicants: JIANGSU XCMG CONSTRUCTION MACHINERY RESEARCH INSTITUTE LTD., Xuzhou, Jiangsu (CN); JIANGSU XCMG STATE KEY LABORATORY TECHNOLOGY CO., LTD., Xuzhou, Jiangsu (CN)

(72) Inventors: Jian ZHANG, Xuzhou (CN); Houxue MA, Xuzhou (CN); Jian LIU, Xuzhou (CN); Hongjun PU, Xuzhou (CN)

(21) Appl. No.: 18/865,619

(22) PCT Filed: Oct. 23, 2023
(86) PCT No.: PCT/CN2023/125899

§ 371 Date: Nov. 13, 2024

(30) Foreign Application Priority Data
Sep. 12, 2023 (CN) 202311169255.6

(51) Int. Cl. E02F 9/26; E02F 3/43; G01B 5/004

(52) U.S. Cl. CPC E02F 9/264; E02F 3/432; G01B 5/004

(57) ABSTRACT

The present disclosure relates to a method, apparatus and system for estimating the coordinates of the bucket tooth tip, an excavator and a storage medium. The method includes: establishing a kinematic model of an excavator according to dimensions of a plurality of components of the excavator, and obtaining measured values of the coordinates of the bucket tooth tip of the excavator according to angles of the plurality of components of the excavator measured by excavator sensors with the kinematic model; obtaining a system noise and a measurement noise of the coordinates of the bucket tooth tip of the excavator; and determining estimated values of the coordinates of the bucket tooth tip of the excavator according to the measured values of the coordinates of the bucket tooth tip of the excavator, the system noise and the measurement noise of the coordinates of the bucket tooth tip of the excavator.

### CROSS-REFERENCE TO RELATED APPLICATIONS

The present disclosure is based on and claims priority of Chinese application for invention No. CN202311169255.6, filed on Sep. 12, 2023, the disclosure of which is hereby incorporated into the present disclosure by reference in its entirety.

### TECHNICAL FIELD

The present disclosure relates to the field of engineering machinery technology, in particular to a method, apparatus and system for estimating coordinates of a bucket tooth tip, an excavator and a storage medium.

### BACKGROUND

The excavator is a multifunctional engineering machinery widely used in construction scenarios such as mining, water conservancy, transportation, and power engineering, etc. Unmanned excavators can replace excavator operators to operate and construct in scenarios with landslide hazards, toxic and harmful gases, while alleviating labor shortages caused by the aging of modern society. During the construction of an unmanned excavator, it is necessary to accurately estimate the three-dimensional coordinates of its bucket tooth tip in an excavator body coordinate system or other fixed coordinate systems, so as to determine parameters such as the distance and angle that the bucket needs to move, and to provide input parameters and a basis for decision-making, planning and other control functional modules of the unmanned excavator. With the increasing quality requirements of customers for excavator operations in solid waste treatment, trenching, slope leveling, mining and other construction operations, the improvement of the measurement and calculation accuracy of the three-dimensional coordinates of the bucket tooth tip of the excavator can effectively improve the construction accuracy and construction quality of the excavator.

### SUMMARY

According to one aspect of the present disclosure, there is provided a method for estimating coordinates of a bucket tooth tip, comprising: establishing a kinematic model of an excavator according to dimensions of a plurality of components of the excavator, and obtaining measured values of the coordinates of the bucket tooth tip of the excavator according to angles of the plurality of components of the excavator measured by excavator sensors with the kinematic model; obtaining a system noise and a measurement noise of the coordinates of the bucket tooth tip of the excavator; and determining estimated values of the coordinates of the bucket tooth tip of the excavator according to the measured values of the coordinates of the bucket tooth tip of the excavator, the system noise and the measurement noise of the coordinates of the bucket tooth tip of the excavator.

In some embodiments of the present disclosure, the obtaining system noise and a measurement noise in the coordinates of the bucket tooth tip of the excavator comprises: determining a measurement error covariance in the process of angle measurement and determining a system noise covariance in the process of coordinate calculation of the excavator.

In some embodiments of the present disclosure, the determining the estimated values of the coordinates of the bucket tooth tip of the excavator according to the measured values of the coordinates of the bucket tooth tip of the excavator, the system noise and the measurement noise of the coordinates of the bucket tooth tip of the excavator, comprises: determining the estimated values of the coordinates of the bucket tooth tip of the excavator by using a predetermined filter to estimate the measured values of the coordinates of the bucket tooth tip of the excavator, according to the measured values of the coordinates of the bucket tooth tip of the excavator, the system noise and the measurement noise of the coordinates of the bucket tooth tip of the excavator.

In some embodiments of the present disclosure, the determining the estimated values of the coordinates of the bucket tooth tip of the excavator by using a predetermined filter to estimate the measured values of the coordinates of the bucket tooth tip of the excavator, according to the measured values of the coordinates of the bucket tooth tip of the excavator, the system noise and the measurement noise of the coordinates of the bucket tooth tip of the excavator, comprises: obtaining a predicted value of a state vector at a moment k+1 according to the state vector at a moment k, wherein the state vector is a state vector of a system for estimating the coordinates of the bucket tooth tip, and the state vector represents the coordinates of the bucket tooth tip of the excavator at a moment; obtaining the predicted value of an error covariance matrix at the moment k+1 according to an estimated value of the error covariance matrix at the moment k, wherein the error covariance matrix is configured to represent estimation accuracy of the state vector; and estimating the state vector and the error covariance matrix at the moment k+1 to obtain estimated values of the state vector and the error covariance matrix at the moment k+1, according to the predicted values of the state vector and the error covariance matrix at the moment k+1, and measured value output by the system at the moment k+1.

In some embodiments of the present disclosure, the determining the estimated values of the coordinates of the bucket tooth tip of the excavator by using a predetermined filter to estimate the measured values of the coordinates of the bucket tooth tip of the excavator, according to the measured values of the coordinates of the bucket tooth tip of the excavator, the system noise and the measurement noise of the coordinates of the bucket tooth tip of the excavator, further comprises: assigning the estimated values of the state vector and the error covariance matrix at the moment k+1 to the step of obtaining a predicted value of the state vector at the moment k+1 according to the state vector at the moment k and the step of obtaining the predicted value of the error covariance matrix at the moment k+1 according to an estimated value of the error covariance matrix at the moment k, to iteratively predict values of the state vector and the error covariance matrix at a next moment.

In some embodiments of the present disclosure, the obtaining a predicted value of the state vector at the moment k+1 according to the state vector at the moment k, comprises: defining the state vector; establishing a dynamic model of the system for estimating the coordinates of the bucket tooth tip, wherein the dynamic model is a state transition matrix configured to represent a transformation relationship between the state vector at the moment k and the state vector at the moment k+1; and obtaining the predicted value of the state vector at the moment k+1 according to the state vector at the moment k and the state transition matrix.

In some embodiments of the present disclosure, the obtaining the predicted value of the error covariance matrix at the moment k+1 according to the estimated value of the error covariance matrix at the moment k, comprises: defining a covariance matrix of a system process noise; and obtaining the predicted value of the error covariance matrix at the moment k+1 according to the estimated value of the error covariance matrix at the moment k, the state transition matrix, and the covariance matrix of the system process noise.

In some embodiments of the present disclosure, the estimating the state vector and the error covariance matrix at the moment k+1 to obtain estimated values of the state vector and the error covariance matrix at the moment k+1, according to the predicted values of the state vector and the error covariance matrix at the moment k+1 and measured values output by the system at the moment k+1, comprises: determining a filter gain value at the moment k+1 according to the predicted value of the error covariance matrix at the moment k+1, a system measurement matrix of the coordinates of the bucket tooth tip and a covariance matrix of the measurement noise; estimating the state vector at the moment k+1 to obtain the estimated value of the state vector at the moment k+1, according to the predicted value of the state vector at the moment k+1, the filter gain value at the moment k+1 and the measured values of the system output at the moment k+1; and estimating the error covariance matrix at the moment k+1 to obtain the estimated value of the error covariance matrix at the moment k+1, according to the predicted value of the error covariance matrix at the moment k+1 and the filter gain value at the moment k+1.

In some embodiments of the present disclosure, the determining the filter gain value at the moment k+1 according to the predicted value of the error covariance matrix at the moment k+1, the system measurement matrix of the coordinates of the bucket tooth tip and the covariance matrix of the measurement noise, comprises: determining an estimation variance according to the predicted value of the error covariance matrix at the moment k+1 and the system measurement matrix of the coordinates of the bucket tooth tip; determining a total variance according to the estimation variance and the covariance matrix of measurement noise; and determining the filter gain value at the moment k+1 according to a ratio of the estimation variance to the total variance.

In some embodiments of the present disclosure, the estimating the state vector at the moment k+1 to obtain the estimated value of the state vector at the moment k+1, according to the predicted value of the state vector at the moment k+1, the filter gain value at the moment k+1 and the measured values of the system output at the moment k+1, comprises: defining a measurement vector of the coordinates of the bucket tooth tip; establishing a measurement model of the system for estimating coordinates of the bucket tooth tip, wherein the measurement model is used to map the state vector to the measurement vector; determining a measurement vector value at the moment k+1 according to the predicted value of the state vector at the moment k+1 and the system measurement matrix of the coordinates of the bucket tooth tip; and estimating the state vector at the moment k+1 to obtain the estimated value of the state vector at the moment k+1, according to the measurement vector value at the moment k+1, the predicted value of the state vector at the moment k+1, the filter gain value at the moment k+1 and the measured values of the system output at the moment k+1.

In some embodiments of the present disclosure, the estimating the error covariance matrix at the moment k+1 to obtain the estimated value of the error covariance matrix at the moment k+1, according to the predicted value of the error covariance matrix at the moment k+1 and the filter gain value at the moment k+1, comprises: estimating the error covariance matrix at the moment k+1 to obtain the estimated value of the error covariance matrix at the moment k+1, according to the predicted value of the error covariance matrix at the moment k+1, the system measurement matrix of the coordinates of the bucket tooth tip and the filter gain value at the moment k+1.

In some embodiments of the present disclosure, the establishing the kinematic model of the excavator according to the dimensions of the plurality of components of the excavator, comprises: establishing five coordinate systems at different components of the excavator, wherein the origins of the five coordinate systems are respectively: an intersection of a vertical axis around which a rotary platform of the excavator rotates and the ground, a connection joint between a boom and the rotary platform of the excavator, a connection joint between the boom and a stick of the excavator, a joint between the stick and a bucket of the excavator, and the bucket tooth tip, wherein a coordinate system taking the intersection of the vertical axis around which the rotary platform of the excavator rotates and the ground as the origin is an excavator coordinate system.

According to another aspect of the present disclosure, there is provided an apparatus for estimating coordinates of a bucket tooth tip, comprising: a coordinate measurement unit configured to establish a kinematic model of an excavator according to dimensions of a plurality of components of the excavator, and obtaining measured values of the coordinates of the bucket tooth tip of the excavator according to angles of the plurality of components of the excavator measured by excavator sensors with the kinematic model; a noise acquisition unit configured to obtain a system noise and a measurement noise of the coordinates of the bucket tooth tip of the excavator; and a coordinate estimation unit configured to determine estimated values of the coordinates of the bucket tooth tip of the excavator according to the measured values of the coordinates of the bucket tooth tip of the excavator, the system noise and the measurement noise of the coordinates of the bucket tooth tip of the excavator.

According to still another aspect of the present disclosure, there is provided an apparatus for estimating coordinates of a bucket tooth tip, comprising: a memory configured to store computer instructions; and a processor configured to execute the instructions, so that the apparatus for the coordinates of the bucket tooth tip performs the method as described in any of the above embodiments.

According to a further aspect of the present disclosure, there is provided a system for estimating coordinates of a bucket tooth tip, comprising excavator dynamic sensors and the apparatus as described in any of the above embodiments.

In some embodiments of the present disclosure, the excavator dynamic sensors comprise at least one of a rotary encoder for measuring a rotation angle of a rotary platform of the excavator, a boom inclinometer for measuring a boom angle, a stick inclinometer for measuring a stick angle, and a bucket inclinometer for measuring a bucket angle.

According to a further aspect of the present disclosure, there is provided an excavator, comprising the system as described in any of the above embodiments.

According to a still another aspect of the present disclosure, there is provided a computer-readable storage medium stored thereon computer instructions that, when executed by a processor, perform the method as described in any of the above embodiments.

According to a still another aspect of the present disclosure, there is provided a computer program, comprising: instructions that, when executed by a processor, cause the processor to perform the method as described in any of the above embodiments.

### BRIEF DESCRIPTION OF THE DRAWINGS

In order to more clearly explain the embodiments of the present invention or the technical solutions in the prior art, a brief introduction will be given below for the drawings required to be used in the description of the embodiments or the prior art. It is obvious that, the drawings illustrated as follows are merely some embodiments of the present disclosure. For a person skilled in the art, he or she may also acquire other drawings according to such drawings on the premise that no inventive effort is involved.

FIG. 1 is a schematic diagram of an excavator according to some embodiments of the present disclosure.

FIG. 2 is a schematic diagram of an excavator according to other embodiments of the present disclosure.

FIG. 3 is a schematic diagram of a method for estimating coordinates of a bucket tooth tip according to some embodiments of the present disclosure.

FIG. 4 is a schematic diagram of a method for estimating the coordinates of the bucket tooth tip according to other embodiments of the present disclosure.

FIG. 5 is a schematic diagram of an apparatus for estimating the coordinates of the bucket tooth tip according to some embodiments of the present disclosure.

FIG. 6 is a structural diagram of a coordinate estimation unit according to some embodiments of the present disclosure.

FIG. 7 is a schematic structural diagram of an apparatus for estimating the coordinates of the bucket tooth tip according to other embodiments of the present disclosure.

### DETAILED DESCRIPTION

Below, a clear and complete description will be given for the technical solution of embodiments of the present disclosure with reference to the figures of the embodiments. Obviously, merely some embodiments of the present disclosure, rather than all embodiments thereof, are given herein. The following description of at least one exemplary embodiment is in fact merely illustrative and is in no way intended as a limitation to the invention, its application or use. All other embodiments acquired by those of ordinary skill in the art based on the embodiments of the present disclosure without creative efforts shall fall within the protection scope of the present disclosure.

Unless otherwise specified, the relative arrangement, numerical expressions and values of the components and steps set forth in these examples do not limit the scope of the invention.

At the same time, it should be understood that, for ease of description, the dimensions of the various parts shown in the drawings are not drawn to actual proportions.

Techniques, methods, and apparatus known to those of ordinary skill in the relevant art may not be discussed in detail, but where appropriate, these techniques, methods, and apparatuses should be considered as part of the specification.

Of all the examples shown and discussed herein, any specific value should be construed as merely illustrative and not as a limitation. Thus, other examples of exemplary embodiments may have different values.

Notice that, similar reference numerals and letters are denoted by the like in the accompanying drawings, and therefore, once an item is defined in a drawing, there is no need for further discussion in the accompanying drawings.

The inventor found through research that various internal and external factors, such as fluctuations in the hydraulic cylinders of the boom and bucket, can cause variations in angles, such as the stick angle and the boom angle, during the automatic construction process of an unmanned excavator. These fluctuations can cause system noise in the process of measuring the three-dimensional coordinates of the bucket tooth tip of the excavator. Inclinometers, rotational encoders and other sensors are used to continuously measure angles such as the stick angle and the boom angle at constant intervals, and measurement noise is comprised in the angle measurement values of the excavator components, resulting in measurement noise during the process of measuring the three-dimensional coordinates of the bucket tooth tip. These two types of noises can increase the detection error of the three-dimensional coordinates of the bucket tooth tip of the excavator, reduce the accuracy and quality of excavator construction and thus affect the construction effect.

The inventor also found through research that the relevant technology cannot effectively deal with the system noise and the measurement noise during the process of measuring the three-dimensional coordinates of the bucket tooth tip of the excavator, resulting in the inability of the three-dimensional coordinates of the bucket tooth tip of the excavator to meet the requirements of high-precision trenching, sloping and other construction scenarios.

In view of at least one of the above technical issues, the present disclosure provides a method, apparatus, and system for estimating the coordinates of the bucket tooth tip, an excavator and a storage medium, which can improve the measurement accuracy of the three-dimensional coordinates of the bucket tooth tip and improve the construction quality of the excavator. The present disclosure will be described in detail below in conjunction with specific embodiments.

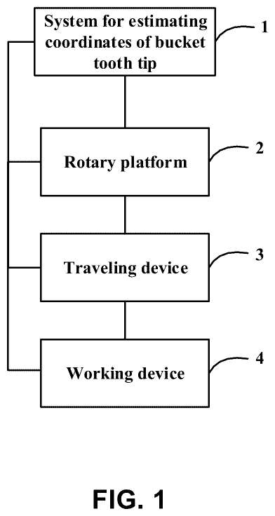

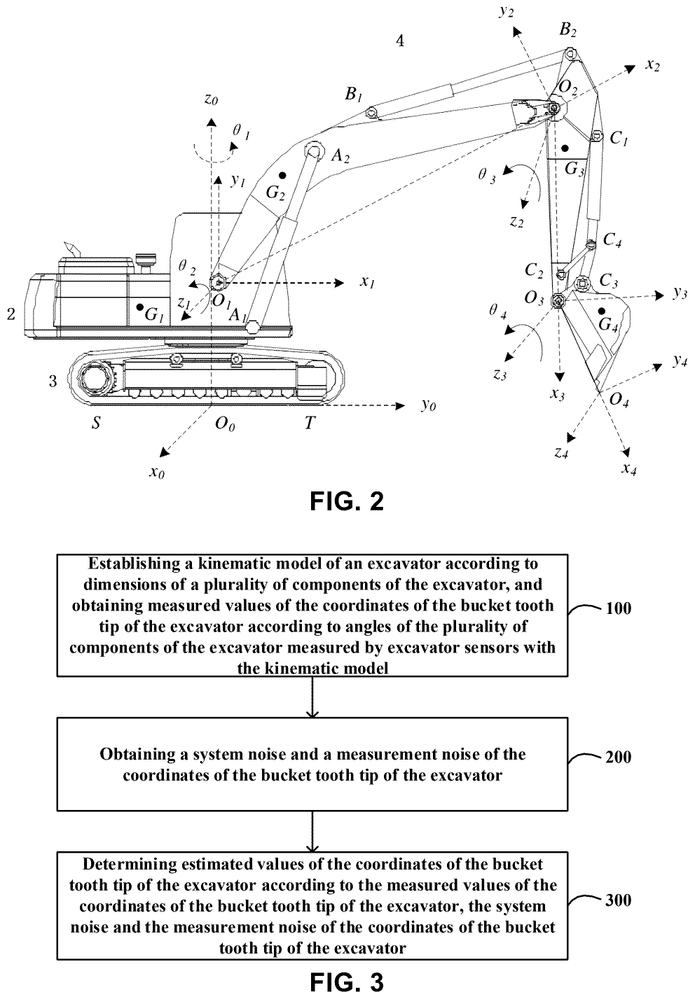

FIG. 1 is a schematic diagram of an excavator according to some embodiments of the present disclosure. FIG. 2 is a schematic diagram of an excavator according to other embodiments of the present disclosure. As shown in FIGS. 1 and 2, the excavator of the present disclosure is composed of four parts: a system 1 for estimating the coordinates of the bucket tooth tip, a rotary platform 2, a traveling device 3 and a working device 4. The working device is mainly composed of three components: a boom, a stick and a bucket, which are jointed together with other auxiliary connecting rods. The excavator comprises a bucket, which is a component directly involved in excavation and planning tasks; the body of the hydraulic excavator is mainly composed of the rotary platform, on which power devices, transmission systems and the operating room of the excavator are carried or mounted. The rotary platform is connected to the traveling device by a rotary device, and can rotate in a circular motion according to the needs of the excavation task, and the working device rotates accordingly. The traveling device of the fully hydraulic excavator is driven by hydraulic motors to complete actions such as traveling, moving, transferring, etc. In the operation of the hydraulic excavator, the traveling device and the rotary platform are driven by a traveling motor and a rotating motor, respectively; the components of the working device are driven by corresponding hydraulic cylinders.

The system 1 for estimating the coordinates of the bucket tooth tip is used for establishing a kinematic model of an excavator according to dimensions of a plurality of components of the excavator, and obtaining measured values of the coordinates of the bucket tooth tip of the excavator according to angles of the plurality of components of the excavator measured by excavator sensors with the kinematic model; obtaining a system noise and a measurement noise of the coordinates of the bucket tooth tip of the excavator; and determining estimated values of the coordinates of the bucket tooth tip of the excavator according to the measured values of the coordinates of the bucket tooth tip of the excavator, the system noise and the measurement noise of the coordinates of the bucket tooth tip of the excavator.

The present disclosure can improve the measurement accuracy of the three-dimensional coordinates of the bucket tooth tip and improve the construction quality of the excavator.

The method and system for estimating the coordinates of the bucket tooth tip of the present disclosure will be described below with specific embodiments.

FIG. 3 is a schematic diagram of a method according to some embodiments of the present disclosure. The embodiment of FIG. 3 can be executed by the apparatus or system for estimating the coordinates of the bucket tooth tip of the present disclosure, or by the excavator of the present disclosure. As shown in FIG. 3, the method of the embodiment in FIG. 3 may comprise at least one of steps 100 to 300.

In step 100, a kinematic model of an excavator is established according to dimensions of a plurality of components of the excavator, and measured values of the coordinates of the bucket tooth tip of the excavator are obtained according to angles of the plurality of components of the excavator measured by excavator sensors with the kinematic model.

In some embodiments of the present disclosure, the excavator comprises four dynamic sensors, namely a rotary encoder for measuring a rotation angle of a rotary platform of the excavator, a boom inclinometer for measuring a boom angle, a stick inclinometer for measuring a stick angle and a bucket inclinometer for measuring a bucket angle.

In some embodiments of the present disclosure, step 100 may comprise: establishing five coordinate systems at different components of the excavator, wherein the origins of the five coordinate systems are respectively: an intersection of a vertical axis around which a rotary platform of the excavator rotates and the ground, a connection joint between a boom and the rotary platform of the excavator, a connection joint between the boom and a stick of the excavator, a joint between the stick and a bucket of the excavator and the bucket tooth tip, wherein a coordinate system taking the intersection of the vertical axis around which the rotary platform of the excavator rotates and the ground as the origin is an excavator coordinate system.

FIG. 2 also shows a schematic diagram of an excavator model and its coordinate systems according to some embodiments of the present disclosure. As shown in FIG. 2, step 100 may comprise: establishing five coordinate systems at different components of the excavator, wherein the origins of the five coordinate systems are respectively: an intersection of a vertical axis Z0 around which a rotary platform of the excavator rotates and the ground, a connection joint between a boom and the rotary platform of the excavator, a connection joint between the boom and a stick of the excavator, a joint between the stick and a bucket of the excavator and the bucket tooth tip, wherein the intersection of the vertical axis Z0 around which the rotary platform of the excavator rotates and the ground is the origin of an excavator coordinate system; establishing a kinematic model of an excavator according to dimensions of a plurality of components of the excavator; and obtaining measured values of the coordinates of the bucket tooth tip of the excavator according to angles of the plurality of components of the excavator measured by excavator sensors with the kinematic model, wherein the measured values of the coordinates of the bucket tooth tip of the excavator is the coordinates of the bucket tooth tip of the excavator calculated according to angles of the plurality of components of the excavator measured by excavator sensors with the kinematic model.

In some embodiments of the present disclosure, as shown in FIG. 2, step 100 may comprise: defining five sets of generalized coordinates θi (i=0,1,2,3,4) to describe the relative rotation between every two adjacent rigid bodies, according to the excavator model and its corresponding coordinate systems Oi-xiyizi (i=0,1,2,3,4). In the present disclosure, a coordinate system is fixed on each connection rod of the excavator, and then the spatial relationship between two adjacent connection rods is described by using a 4×4 homogeneous transformation matrix. By sequential transformation, the pose of an end effector relative to the base coordinate system can be derived, thereby establishing a kinematic equation of the excavator.

In some embodiments of the present disclosure, as shown in FIG. 2, the excavator coordinate system is O0-x0y0z0, the plane x0y0 overlaps with the ground, and the rotary platform of the excavator rotates about the axis Z0. O102 is an equivalent boom, O203 is an equivalent stick, O304 is an equivalent bucket construction surface, and O4 is the bucket tooth tip.

In some embodiments of the present disclosure, step 100 may comprise: determining a relative displacement between the bucket tooth tip and the boom fulcrum in the vehicle body coordinate system according to a boom inclination angle, a stick inclination angle and a bucket inclination angle of the excavator, as well as a boom length, a stick length and a bucket length of the excavator; determining a real-time position of the bucket tooth tip in the vehicle body coordinate system according to the relative displacement between the bucket tooth tip and the boom fulcrum in the vehicle body coordinate system, as well as a real-time position of the boom fulcrum in the vehicle body coordinate system.

In some embodiments of the present disclosure, step 100 may comprise: determining a coordinate transformation matrix between the vehicle body coordinate system and the world coordinate system according to vehicle posture information of the excavator; determining a relative displacement between the bucket tooth tip and the boom fulcrum in the vehicle body coordinate system according to a boom inclination angle, a stick inclination angle and a bucket inclination angle of the excavator, as well as a boom length, a stick length and a bucket length of the excavator; determining a relative displacement between the bucket tooth tip and the boom fulcrum in the world coordinate system, according to the relative displacement between the bucket tooth tip and the boom fulcrum in the vehicle body coordinate system and the coordinate transformation matrix; determining a real-time position of the bucket tooth tip in the world coordinate system according to the relative displacement between the bucket tooth tip and the boom fulcrum in the world coordinate system, as well as a real-time position of the boom fulcrum in the world coordinate system. In the present disclosure, the vehicle body coordinate system of the excavator is located in the world coordinate system to obtain the three-dimensional (3D) coordinate values of the bucket tooth tip in the vehicle body coordinate system O0-x0y0z0 of the excavator by measurement.

In step 200, a system noise and a measurement noise of the coordinates of the bucket tooth tip of the excavator are obtained.

In some embodiments of the present disclosure, step 200 may comprise: determining a measurement error covariance in the process of angle measurement and determining a system noise covariance in the process of coordinate calculation of the excavator.

In some embodiments of the present disclosure, step 200 may comprise: analyzing the characteristics of the excavator body and the sensors to obtain the system noise and the measurement noise in the 3D coordinates of the bucket tooth tip of the excavator.

In step 300, estimated values of the coordinates of the bucket tooth tip of the excavator are determined according to the measured values of the coordinates of the bucket tooth tip of the excavator, the system noise and the measurement noise of the coordinates of the bucket tooth tip of the excavator.

In some embodiments of the present disclosure, step 300 may comprise: determining the estimated values of the coordinates of the bucket tooth tip of the excavator by using a predetermined filter to estimate the measured values of the coordinates of the bucket tooth tip of the excavator, according to the measured values of the coordinates of the bucket tooth tip of the excavator, the system noise and the measurement noise of the coordinates of the bucket tooth tip of the excavator.

In some embodiments of the present disclosure, the predetermined filter may be a Kalman filter.

In some embodiments of the present disclosure, step 300 may comprise at least one of steps 310 to 340.

In step 310, a predicted value of a state vector at a moment k+1 is obtained according to the state vector at a moment k, wherein the state vector is a state vector of a system for estimating the coordinates of the bucket tooth tip, and the state vector represents the coordinates of the bucket tooth tip of the excavator.

In some embodiments of the present disclosure, step 310 may comprise at least one of steps 311 to 313.

In step 311, the state vector is defined.

In some embodiments of the present disclosure, step 311 may comprise: defining the state vector W(k)−[x(k),y(k),z(k)] of the system for estimating 3D coordinates of the bucket tooth tip, which comprises 3D coordinates of the bucket tooth tip of the excavator on the x-axis, y-axis and z-axis, respectively. W (k) is a 3×1 vector.

In step 312, a dynamic model of the system for estimating the coordinates of the bucket tooth tip is established, wherein the dynamic model is a state transition matrix configured to represent a transformation relationship between the state vector at the moment k and the state vector at the moment k+1.

In some embodiments of the present disclosure, step 312 may comprise: establishing a dynamic model of the system for estimating the coordinates of the bucket tooth tip as shown in formula (1).

$$\hat{W} ( k + 1 ) = A W ( k ) \qquad ( 1 )$$

The model of formula (1) describes the transformation relationship between the state vector at the moment k and the state vector at the moment k+1.

A in formula (1) represents a state transition matrix, which is the system dynamic model.

In some embodiments of the present disclosure, the state transition matrix A for a Kalman filter is as follows.

$$A = [ \begin{matrix}1 & 0 & 0 \\ 0 & 1 & 0 \\ 0 & 0 & 1\end{matrix} ]$$

In step 313, the predicted value of the state vector at the moment k+1 is obtained according to the state vector at the moment k and the state transition matrix.

In some embodiments of the present disclosure, step 313 may comprise: inputting the state vector and the state transition matrix at the moment k into the dynamic model of the system for estimating the coordinates of the bucket tooth tip (e.g., inputting to formula (1)), and obtaining the predicted values of the state vector at the moment k+1.

In the excavator coordinate estimation in the above embodiment, it is necessary to refer to the values at a previous time point. Here, the use of the identity matrix is a common way to introduce the values at the previous time point into the Kalman filter. Formula (1) is a prediction formula for state variables, indicating that the values at the moment k+1 depend on the values at the moment k.

In some embodiments of the present disclosure, a difference between the predicted value at the moment k+1 obtained using formula (1) and the actual measured value at the moment k+1 is calculated, and then used in conjunction with a Kalman gain to obtain the estimated variable value at the moment k+1 by using formula (4).

In step 320, the predicted value of an error covariance matrix at the moment k+1 is obtained according to an estimated value of the error covariance matrix at the moment k, wherein the error covariance matrix is configured to represent the estimation accuracy of the state vector.

In some embodiments of the present disclosure, step 320 may comprise at least one of steps 321 to 322.

In step 321, a covariance matrix Q of the system process noise is defined.

In some embodiments of the present disclosure, the equation for state transition from the estimated values W (k) of the 3D coordinates at the moment k to the estimated values W (k+1) of the 3D coordinates at the moment k+1 is shown in formula (2-1).

$$W ( k + 1 ) = AW ( k ) + w \qquad ( 2 - 1 )$$

In formula (2-1), w is the process noise.

In some embodiments of the present disclosure, Q represents a covariance matrix of the system process noise, which is Gaussian white noise. Q is a 3×3 matrix.

In some embodiments of the present disclosure, the values of Q are as follows.

$$Q = [ \begin{matrix}5 & 0 & 0 \\ 0 & 5 & 0 \\ 0 & 0 & 10\end{matrix} ]$$

In some embodiments of the present disclosure, the covariance matrix Q of the system process noise has initial values selected according to experience. The fluctuation ranges on the axes x, y and z during excavator adjustment are approximately 5 centimeters, 5 centimeters and 10 centimeters, respectively. The covariance matrix Q of the system process noise will be adjusted in a subsequent adjustment process according to the filtering effect.

In some embodiments of the present disclosure, the covariance matrix Q of the system process noise is calculated according to formula (2-2).

$$Q = cov ( w ) = E \{ {ww}^{T} \} \qquad ( 2 - 2 )$$

In formula (2-2), E{•} represents the expected value.

In step 322, the predicted value of the error covariance matrix at the moment k+1 is obtained according to the estimated value of the error covariance matrix at the moment k, the state transition matrix, and the covariance matrix of the system process noise.

In some embodiments of the present disclosure, step 322 may comprise: obtaining the predicted values of the error covariance matrix at the moment k+1 according to formula (2).

$$\hat{P} ( k + 1 ) = AP ( k ) {A}^{T} + Q \qquad ( 2 )$$

In formula (2), P(k) is the error covariance at the moment k. \hat{P}(k+1) is the predicted values of the error covariance at the moment k+1; \hat{P}(k+1) is the predicted values of the error covariance at the moment k+1 calculated based on the error covariance at the moment k, which is a 3×3 matrix.

In some embodiments of the present disclosure, the state transition matrix A in formula (2) of the Kalman filtering system is used to determine the predicted value of the system noise.

In step 330, the state vector and the error covariance matrix at the moment k+1 are estimated to obtain estimated values of the state vector and the error covariance matrix at the moment k+1, according to the predicted values of the state vector and the error covariance matrix at the moment k+1 and measured values output by the system at the moment k+1.

In some embodiments of the present disclosure, step 330 may comprise at least one of steps 331 to 333.

In step 331, a filter gain value at the moment k+1 is determined according to the predicted value of the error covariance matrix at the moment k+1, a system measurement matrix of the coordinates of the bucket tooth tip and a covariance matrix of the measurement noise.

In some embodiments of the present disclosure, step 331 may comprise at least one of steps 3311 to 3315.

In step 3311, a measurement vector of the coordinates of the bucket tooth tip is defined.

In some embodiments of the present disclosure, step 3311 may comprise: defining a measurement vector S(k)=[x(k),y(k),z(k)] for the system for estimating the coordinates of the bucket tooth tip. As the state vector, the measurement vector in the present disclosure is also configured to represent the coordinates of the bucket tooth tip of the excavator. S(k) represents the coordinate values of the bucket tooth tip of the excavator calculated based on measurement values of the sensors.

In some embodiments of the present disclosure, S(k+1)=[x(k+1),Y(k+1),z(k+1)], indicating that the measured values of the 3D coordinates of the bucket tooth tip of the excavator at the moment k+1 are represented by a 3×1 vector.

In step 3312, a measurement model of the system for estimating coordinates of the bucket tooth tip is established, wherein the measurement model is used to map the state vector to the measurement vector.

In some embodiments of the present disclosure, step 3312 may comprise: establishing a measurement model of the system for estimating coordinates of the bucket tooth tip to determine how to map the system state vector to the measurement vector using, for example, formula (3-1). In the present disclosure, the state vector is the same as the measurement vector. In addition, measurement noise also needs to be considered in this equation. Y(k+1) represents the values of the measurement vector calculated based on the predicted values of the coordinates of the bucket tooth tip at the moment k+1.

$$Y ( k + 1 ) = H \hat{W} ( k + 1 ) \qquad ( 3 - 1 )$$

In formula (3-1), H is the system measurement matrix of the 3D coordinates of the bucket tooth tip of the excavator, which is a 3×3 matrix.

In some embodiments of the present disclosure, the values of H are as follows.

$$H = [ \begin{matrix}1 & 0 & 0 \\ 0 & 1 & 0 \\ 0 & 0 & 1\end{matrix} ]$$

In the present disclosure, H is an identity matrix, indicating that the values to be estimated are the same as the values of the state variables. This matrix H is mainly used for related calculations in formulas (3), (4) and (5) in a Kalman filtering system. The reserved identity matrix H here is also a preparation for future adjustment and optimization. If the variables to be measured are some variables based on the state variables, an appropriate change or adjustment can be made to the matrix H accordingly.

In step 3313, an estimation variance is determined according to the predicted values of the error covariance matrix at the moment k+1 and the system measurement matrix of the coordinates of the bucket tooth tip.

In some embodiments of the present disclosure, step 3313 may comprise: determining an estimation variance H\hat{P}(k+1)H^{T} according to the predicted values \hat{P}(k+1) of the error covariance matrix at the moment k+1, the system measurement matrix H of the coordinates of the bucket tooth tip, and a transposition matrix H^{T} of the system measurement matrix.

In step 3314, a total variance is determined according to the estimation variance and the covariance matrix of the measurement noise.

In some embodiments of the present disclosure, step 3314 may comprise: determining a total variance H\hat{P}(k+1)H^{T}+R according to the estimation variance and a covariance matrix R of the measurement noise.

In some embodiments of the present disclosure, R is a covariance matrix of the measurement noise, which is also a Gaussian white noise. R is a 3×3 matrix, and the values of R in this embodiment are as follows.

$$R = [ \begin{matrix}1 & 0 & 0 \\ 0 & 1 & 0 \\ 0 & 0 & 5\end{matrix} ]$$

R has initial values selected according to experience. The fluctuation ranges of the measurement noise on the axes x, y and z are respectively 1 cm, 1 cm and 5 cm. The covariance matrix R of the measurement noise can be adjusted in a subsequent adjustment process.

In some embodiments of the present disclosure, the equations for state transition from the estimated 3D coordinate values at the moment k to the measured 3D coordinate values at the moment k+1 are shown in formulas (2-1) and (3-2).

$$W ( k + 1 ) = AW ( k ) + w \qquad ( 2 - 1 )$$

$$S ( k + 1 ) = HW ( k + 1 ) + v \qquad ( 3 - 2 )$$

In formulas (2-1) and (3-2), w represents the process noise and v represents the measurement noise.

In some embodiments of the present disclosure, the covariance matrix R of the measurement noise can be determined according to formula (3-3), wherein E{•} represents the expected value.

$$R = cov ( v ) = E \{ {vv}^{T} \} \qquad ( 3 - 3 )$$

In step 3315, filter gain values at the moment k+1 is determined according to a ratio of the estimation variance to the total variance.

In some embodiments of the present disclosure, K(k+1) is a Kalman gain matrix at the moment k+1, which is a 3×3 matrix.

In some embodiments of the present disclosure, step 3315 may comprise: determining the filter gain value K(k+1) at the moment k+1 according to formula (3).

$$K ( k + 1 ) = H ( k + 1 ) {{H}^{T} ( H \hat{P} ( k + 1 ) {H}^{T} + R )}^{- 1} \qquad ( 3 )$$

In some embodiments of the present disclosure, the smaller the value of the process noise Q, the greater our confidence in the predicted value of the model and the faster the system converges. In contrast, the opposite is true. The larger the value of the measurement noise R, the lower the confidence in the measurement value, too large value will cause the system to respond slowly, and too small value may cause the system to oscillate. For the value of the process noise Q and the value of the measurement noise R, when adjusting the parameters, one of these parameters can be fixed to adjust the other, for example, the value of Q can be adjusted from small to large value to ensure that the system convergence speed is normal, and the value of R can be adjusted from large to small to make the output result close to the actual value. The value range is the difference between the upper and lower limits of the measured 3D coordinate values in a period of time.

In some embodiments of the present disclosure, for the initial values of W and P, their values determine the initial convergence rate and are generally set to the same order of magnitude or a smaller number than the ideal values to achieve faster convergence. As the iteration proceeds, the value of P will converge to a minimum estimation covariance matrix

In step 332, the state vector at the moment k+1 is estimated to obtain the estimated value of the state vector at the moment k+1, according to the predicted value of the state vector at the moment k+1, the filter gain value at the moment k+1 and the measured values of the system output at the moment k+1.

In some embodiments of the present disclosure, step 332 may comprise at least one of steps 3321 to 3323.

In step 3321, a measurement vector value Y(k+1) at the moment k+1 is determined according to the predicted value Ŵ(k+1) of the state vector at the moment k+1 and the system measurement matrix of the coordinates of the bucket tooth tip.

In some embodiments of the present disclosure, step 3321 may comprise: determining the measurement vector value Y(k+1) at the moment k+1 according to the formula (3-1).

In step 3322, the state vector at the moment k+1 is estimated to obtain the estimated value W(k+1) of the state vector at the moment k+1, according to the measurement vector value Y(k+1) at the moment k+1, the predicted value W(k+1) of the state vector at the moment k+1, the filter gain value K(k+1) at the moment k+1 and the measured value S(k+1) of the system output at the moment k+1.

In some embodiments of the present disclosure, step 3321 may comprise: determining a predicted measurement noise value according to the difference between the measured value S(k+1) output by the system at the moment k+1 and the measurement vector values Y(k+1) at the moment k+1; determining the estimated measurement noise value according to the product of the predicted measurement noise value and the filter gain values K(k+1) at the moment k+1; obtaining the estimated value W(k+1) of the state vector at the moment k+1 according to the estimated measurement noise value and the predicted values Ŵ(k+1) of the state vector at the moment k+1.

In some embodiments of the present disclosure, step 3322 may comprise: determining the measurement vector value Y (k+1) at the moment k+1 according to the formula (4).

$$W ( k + 1 ) = \hat{W} ( k + 1 ) + K ( k + 1 ) ( S ( k + 1 ) - H \hat{W} ( k + 1 ) ) \qquad ( 4 )$$

In step 333, the error covariance matrix at the moment k+1 is estimated to obtain the estimated value of the error covariance matrix at the moment k+1, according to the predicted value of the error covariance matrix at the moment k+1 and the filter gain value at the moment k+1.

In some embodiments of the present disclosure, step 333 may comprise: estimating the error covariance matrix at the moment k+1 to obtain the estimated value of the error covariance matrix at the moment k+1, according to the predicted value \hat{P}(k+1) of the error covariance matrix at the moment k+1, the system measurement matrix H of the coordinates of the bucket tooth tip, an identity matrix I and the filter gain value K(k+1) at the moment k+1.

In some embodiments of the present disclosure, step 333 may comprise: determining a first matrix K(k+1)H according to the product of the system measurement matrix H of the coordinates of the bucket tooth tip and the filter gain value K(k+1) at the moment k+1; determining a difference matrix according to the difference between the identity matrix I and the first matrix; and determining the estimated value P(k+1) of the error covariance matrix at the moment k+1 according to the product of the difference matrix and the predicted value \hat{P}(k+1) of the error covariance matrix at the moment k+1.

In some embodiments of the present disclosure, step 333 may comprise: determining the estimated value P(k+1) of the error covariance matrix at the moment k+1 according to formula (5).

$$P ( k + 1 ) = ( 1 - K ( k + 1 ) H ) \hat{P} ( k + 1 ) \qquad ( 5 )$$

In step 340, the estimated value W(k+1) of the state vector and the estimated value P(k+1) of the error covariance matrix at the moment k+1 are input to the step 310 of obtaining a predicted value of the state vector at the moment k+1 according to the state vector at the moment k and the step 320 of obtaining the predicted value of the error covariance matrix at the moment k+1 according to an estimated value of the error covariance matrix at the moment k, to iteratively predict values of the state vector and the error covariance matrix at a next moment.

The implementation of estimating the 3D coordinate system parameters of the bucket tooth tip of the excavator using a Kalman filter in the above embodiment mainly consists of two steps: a prediction step and an update step. The prediction step comprises at least one of formulas (1) and (2); and the update step comprises at least one of formulas (3), (4) and (5).

From formulas (1) to (5), it can be seen that the five formulas used in a Kalman filtering module for estimating 3D coordinates of the bucket tooth tip of the excavator can be divided into a prediction group (Formulas (1) and (2)) and an update group (Formulas (3), (4) and (5)). The prediction group is always used to predict a current state according to a previous state, and to calculate the predicted value of the 3D coordinates of the bucket tooth tip at the current time. The update group is used to modify the predicted information according to observation information in order to achieve an optimal estimation. In the above equations, W(k+1) is the optimal estimated value of the coordinates of the bucket tooth tip of the excavator output by the Kalman filter.

The inventor also found through research that the fluctuation of the hydraulic cylinders such as the boom cylinder and stick cylinder mounted on the excavator will inevitably cause variations in the angles such as the boom angle and stick angle. Therefore, the 3D coordinates of the bucket tooth tip obtained according to data such as the angles and lengths of the boom and stick will comprise the system noise during the measurement process. Inclinometers, rotational encoders and other sensors are used to continuously measure angles, such as the angles of the boom and stick, at constant intervals. The measurement errors of the inclinometers or rotational encoders may cause measurement noise in the measured angle values of the excavator components, resulting in the measurement noise during the measurement process of the 3D coordinates of the bucket tooth tip. These factors lead to noise in the 3D coordinate calculation result of the bucket tooth tip of the excavator in the vehicle body coordinate system of the excavator, resulting in significant fluctuations and errors in the measurement and calculation of the 3D coordinate values of the tooth tip.

In order to reduce the impact of system noise and measurement noise on the accuracy of the coordinate measurement of the bucket tooth tip of the excavator, firstly, a state spatial model of the 3D coordinate measurement variables is established. Through Kalman filtering, the estimation of the state variables is updated by using the optimal estimation value of a previous state and its error variance estimation, as well as the current measured value, to find the current optimal estimation value. In the present disclosure, the estimation of the current 3D coordinate value depends on the estimation error of the previous time and the current observation value. In the present disclosure, the estimated values are continuously corrected by continuous prediction and actual measurement to achieve a desired smooth state.

The present disclosure can obtain a fast optimal estimation of the coordinates of the bucket tooth tip of the excavator in the vehicle body coordinate system of the excavator, effectively reducing the impact of the system noise and the measurement noise on the 3D coordinate system of the excavator, thereby improving the detection accuracy of the 3D coordinates of the bucket tooth tip, effectively improving the construction quality of the excavator and achieving a good result with low cost.

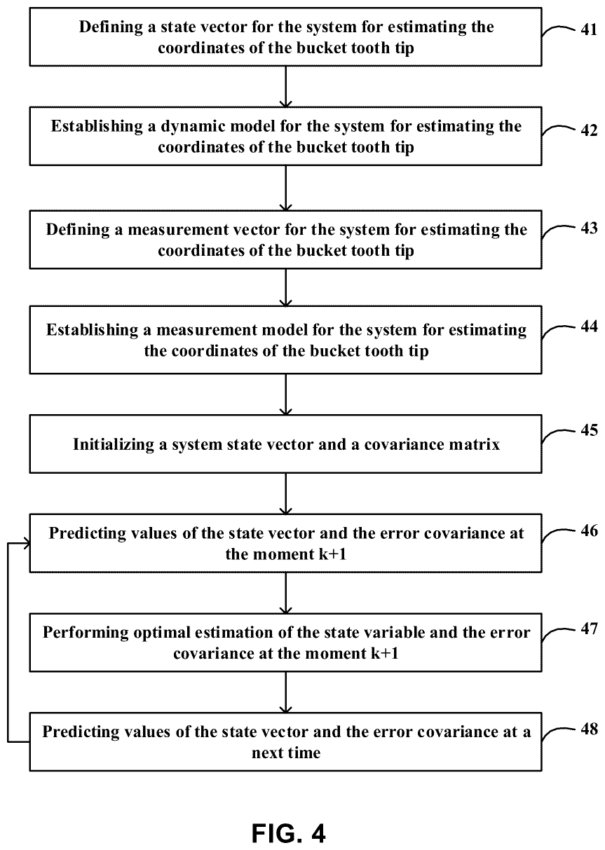

FIG. 4 is a schematic diagram of a method for estimating the coordinates of the bucket tooth tip according to other embodiments of the present disclosure. The embodiment of FIG. 4 can be executed by the apparatus or system for estimating the coordinates of the bucket tooth tip of the present disclosure, or by the excavator of the present disclosure. As shown in FIG. 4, the method of the embodiment in FIG. 4 may comprise at least one of steps 41 to 48.

In step 41, a state vector W(k)=[x(k),y(k),z(k)] is defined for the system for estimating the coordinates of the bucket tooth tip, which comprises 3D coordinates of the bucket tooth tip of the excavator on the x-axis, y-axis and z-axis, respectively.

In step 42, a dynamic model for the system for estimating the coordinates of the bucket tooth tip is established as follows: Ŵ(k+1)=AW(k). This model describes the transformation relationship between the state vector at the moment k and the state vector at the moment k+1.

In some embodiments of the present disclosure, the state transition matrix A for a Kalman filter is as follows.

$$A = [ \begin{matrix}1 & 0 & 0 \\ 0 & 1 & 0 \\ 0 & 0 & 1\end{matrix} ]$$

In step 43, a measurement vector S(k)=[x(k),y(k),z(k)] is defined for the system for estimating the coordinates of the bucket tooth tip. As the state vector, the measurement vector in the present disclosure is also configured to represent the coordinates of the bucket tooth tip of the excavator. S(k) represents the coordinate values of the excavator's bucket tooth tip calculated according to sensor measurement values.

In step 44, a measurement model Y(k+1)=HŴ(k+1) is estimated for the system for estimating the coordinates of the bucket tooth tip, which is used to determine how to map the system state vector to the measurement vector. In the present disclosure, the state vector is the same as the measurement vector. In addition, measurement noise also needs to be considered in this equation. Y(k) represents values of the measurement vector calculated according to the predicted values of the coordinates of the bucket tooth tip at the moment k+1.

In step 45, a system state vector and a covariance matrix are initialized. The covariance matrix describes the estimation accuracy of the state vector, which is set according to the prior knowledge of the excavator bucket tooth tip coordinate system as follows.

$$Q = [ \begin{matrix}5 & 0 & 0 \\ 0 & 5 & 0 \\ 0 & 0 & 10\end{matrix} ]$$

In step 46, values of the state vector and the error covariance at the moment k+1 are predicted according to values of the state vector and the error covariance at the moment k.

In some embodiments of the present disclosure, the step 46 may comprise: predicting values of the state vector and the error covariance at the moment k+1 based on the formulas (1) and (2).

In step 47, optimal estimation of the state variable and the error covariance at the moment k+1 is performed to generate an optimal estimation of the state variable and the error covariance at the moment k+1, according to the predicted values of the state vector and the error covariance at the moment k+1, as well as actual output measured variable values.

In some embodiments of the present disclosure, the step 47 may comprise: generating an optimal estimation of the state variable and the error covariance at the moment k+1 according to the formulas (3), (4) and (5).

In step 48, the optimal estimation of the state variable and the error covariance at the moment k+1 are input to the step 46 to iteratively predict values of the state vector and the error covariance at a next time.

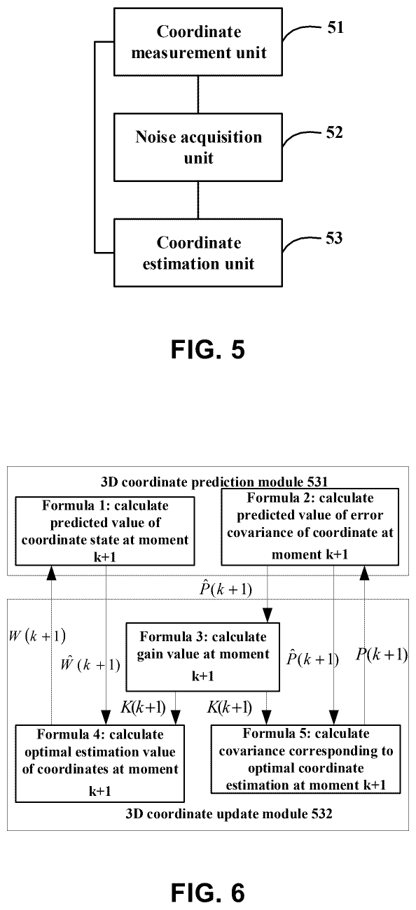

FIG. 5 is a schematic diagram of an apparatus for estimating the coordinates of the bucket tooth tip according to some embodiments of the present disclosure. As shown in FIG. 5, the apparatus for estimating the coordinates of the bucket tooth tip of the present disclosure may comprise a coordinate measurement unit 51, a noise acquisition unit 52, and a coordinate estimation unit 53.

The coordinate measurement unit 51 is configured to establish a kinematic model of an excavator according to dimensions of a plurality of components of the excavator, and obtaining measured values of the coordinates of the bucket tooth tip of the excavator according to angles of the plurality of components of the excavator measured by excavator sensors with the kinematic model.

In some embodiments of the present disclosure, the coordinate measurement unit 51 is configured to establish five coordinate systems at different components of the excavator, wherein the origins of the five coordinate systems are respectively: an intersection of a vertical axis around which a rotary platform of the excavator rotates and the ground, a connection joint between a boom and the rotary platform of the excavator, a connection joint between the boom and a stick of the excavator, a joint between the stick and a bucket of the excavator, and the bucket tooth tip, wherein a coordinate system taking the intersection of the vertical axis around which the rotary platform of the excavator rotates and the ground as the origin is an excavator coordinate system.

The noise acquisition unit 52 is configured to obtain a system noise and a measurement noise of the coordinates of the bucket tooth tip of the excavator.

In some embodiments of the present disclosure, the noise acquisition unit 52 may be configured to determine a measurement error covariance in the process of angle measurement and determine a system noise covariance in the process of coordinate calculation of the excavator.

The coordinate estimation unit 53 is configured to determine estimated values of the coordinates of the bucket tooth tip of the excavator according to the measured values of the coordinates of the bucket tooth tip of the excavator, the system noise and the measurement noise of the coordinates of the bucket tooth tip of the excavator.

In some embodiments of the present disclosure, the coordinate estimation unit 53 is configured to determine the estimated values of the coordinates of the bucket tooth tip of the excavator by using a predetermined filter to estimate the measured values of the coordinates of the bucket tooth tip of the excavator, according to the measured values of the coordinates of the bucket tooth tip of the excavator, the system noise and the measurement noise of the coordinates of the bucket tooth tip of the excavator.

In some embodiments of the present disclosure, the apparatus for estimating the coordinates of the bucket tooth tip can be used to perform the method for estimating the coordinates of the bucket tooth tip as described in any of the above embodiments (such as any of the embodiments shown in FIGS. 3, 4 and 6).

FIG. 6 is a structural diagram of a coordinate estimation unit according to some embodiments of the present disclosure. As shown in FIG. 6, the coordinate estimation unit of the present disclosure (such as the coordinate estimation unit 53 of the embodiment in FIG. 5) can comprise a 3D coordinate prediction module 531 and a 3D coordinate update module 532.

The 3D coordinate prediction module 531 is configured to obtain predicted values of a state vector and an error covariance matrix at the moment k+1 according to the estimated values of the state vector and the error covariance matrix at the moment k, wherein the state vector is a state vector of a system for estimating the coordinates of the bucket tooth tip, the state vector represents the coordinates of the bucket tooth tip of the excavator at a moment and the error covariance matrix is configured to represent the estimation accuracy of the state vector.

In some embodiments of the present disclosure, the 3D coordinate prediction module 531 is configured to obtain a predicted value of a state vector at a moment k+1 according to the state vector at a moment k; obtain the predicted value of an error covariance matrix at the moment k+1 according to an estimated value of the error covariance matrix at the moment k.

In some embodiments of the present disclosure, the 3D coordinate prediction module 531 is configured to define the state vector in the case where the predicted value of the state vector at the moment k+1 is obtained according to the state vector at the moment k; establish a dynamic model of the system for estimating the coordinates of the bucket tooth tip, wherein the dynamic model is a state transition matrix configured to represent a transformation relationship between the state vector at the moment k and the state vector at the moment k+1; and obtain the predicted value of the state vector at the moment k+1 according to the state vector at the moment k and the state transition matrix.

In some embodiments of the present disclosure, the 3D coordinate prediction module 531 is configured to define a covariance matrix of the system process noise in the case where the predicted value of the error covariance matrix at the moment k+1 is obtained according to the estimated value of the error covariance matrix at the moment k; and obtain the predicted value of the error covariance matrix at the moment k+1 according to the estimated value of the error covariance matrix at the moment k, the state transition matrix, and the covariance matrix of the system process noise.

The 3D coordinate update module 532 is configured to estimate the state vector and the error covariance matrix at the moment k+1 to obtain estimated values of the state vector and the error covariance matrix at the moment k+1, according to the predicted values of the state vector and the error covariance matrix at the moment k+1 and measured values output by the system at the moment k+1.

In some embodiments of the present disclosure, the 3D coordinate update module 532 may be configured to determine a filter gain value at the moment k+1 according to the predicted value of the error covariance matrix at the moment k+1, a system measurement matrix of the coordinates of the bucket tooth tip and a covariance matrix of the measurement noise; estimate the state vector at the moment k+1 to obtain the estimated value of the state vector at the moment k+1, according to the predicted value of the state vector at the moment k+1, the filter gain value at the moment k+1 and the measured values of the system output at the moment k+1; and estimate the error covariance matrix at the moment k+1 to obtain the estimated value of the error covariance matrix at the moment k+1, according to the predicted value of the error covariance matrix at the moment k+1 and the filter gain value at the moment k+1.

In some embodiments of the present disclosure, the 3D coordinate update module 532 may be configured to determine an estimation variance according to the predicted value of the error covariance matrix at the moment k+1 and the system measurement matrix of the coordinates of the bucket tooth tip, in the case where the filter gain value at the moment k+1 is determined according to the predicted value of the error covariance matrix at the moment k+1, the system measurement matrix of the coordinates of the bucket tooth tip and the covariance matrix of the measurement noise; determine a total variance according to the estimation variance and the covariance matrix of measurement noise; and determine the filter gain value at the moment k+1 according to a ratio of the estimation variance to the total variance.

In some embodiments of the present disclosure, the 3D coordinate update module 532 may be configured to define a measurement vector of the coordinates of the bucket tooth tip in the case where the state vector at the moment k+1 is estimated to obtain the estimated value of the state vector at the moment k+1, according to the predicted value of the state vector at the moment k+1, the filter gain value at the moment k+1 and the measured values of the system output at the moment k+1; establish a measurement model of the system for estimating coordinates of the bucket tooth tip, wherein the measurement model is used to map the state vector to the measurement vector; determine a measurement vector value at the moment k+1 according to the predicted value of the state vector at the moment k+1 and the system measurement matrix of the coordinates of the bucket tooth tip; and estimate the state vector at the moment k+1 to obtain the estimated value of the state vector at the moment k+1, according to the measurement vector value at the moment k+1, the predicted value of the state vector at the moment k+1, the filter gain value at the moment k+1 and the measured value of the system output at the moment k+1.

In some embodiments of the present disclosure, the 3D coordinate update module 532 may be configured to estimate the error covariance matrix at the moment k+1 to obtain the estimated value of the error covariance matrix at the moment k+1, according to the predicted value of the error covariance matrix at the moment k+1, the system measurement matrix of the coordinates of the bucket tooth tip and the filter gain value at the moment k+1, in the case where the error covariance matrix at the moment k+1 is estimated to obtain the estimated value of the error covariance matrix at the moment k+1, according to the predicted value of the error covariance matrix at the moment k+1 and the filter gain value at the moment k+1.

In some embodiments of the present disclosure, the 3D coordinate update module 532 is further configured to input the estimated values of the state vector and the error covariance matrix at the moment k+1 into the 3D coordinate prediction module 531 to enable the 3D coordinate prediction module 531 to iteratively predict values of the state vector and the error covariance at a next time.

FIG. 6 also provides a schematic diagram of the architecture of the method for estimating the coordinates of the bucket tooth tip according to a Kalman filter. As shown in FIG. 6, the architecture of the method for estimating 3D coordinates of the bucket tooth tip according to a Kalman filter is composed of formulas (1) to (5) provided in the present disclosure.

In some embodiments of the present disclosure, as shown in FIG. 6, the 3D coordinate prediction module 531 mainly contains the formulas (1) and (2), which are mainly used to predict values at the moment k+1 according to the optimal estimation of the state vector and the error covariance matrix at the moment k.

In some embodiments of the present disclosure, as shown in FIG. 6, the 3D coordinate update module 532 mainly contains the formulas (3), (4) and (5), which are mainly used to perform the optimal estimation of the state vector and the error covariance matrix at the moment k+1, according to the predicted values of the state vector and the error covariance matrix at the moment k+1, as well as measured values output by the system at the moment k+1.

In some embodiments of the present disclosure, as shown in FIG. 6, the formulas used in the Kalman filter for estimating 3D coordinates of the bucket tooth tip of the excavator and their relationship are as follows.

Formula (1) is configured to calculate the predicted value of the system state at the moment k+1 according to the value of the state at the moment k, wherein Ŵ(k+1) is the predicted value of the state at the moment k+1 according to the values of the state at the moment k; W(k) is the optimal result of the state at the moment k; in the equation, A is a state transition matrix; formula (1) transmits the predicted value Ŵ(k+1) of the prediction variables to the formula (4) and receives the optimal estimation value W(k+1) of the state variables sent by the formula (4).

Formula (2) is configured to calculate the predicted value of an error covariance corresponding to Ŵ(k+1), wherein \hat{P}(k+1) is the predicted value of the error covariance at the moment k+1 calculated based on the covariance at the moment k, and P(k) is the optimal result of the covariance at the moment k; Q is the covariance of the system process noise; formula (2) transmits the predicted values Ŵ(k+1) of the coordinate error covariance to the formulas (3) and (5) for calculating the gain value and the covariance of the optimal error covariance estimation at the moment k+1, respectively.

Formula (3) is configured to calculate gain value at the moment k+1, wherein K(k+1) is the gain of the Kalman filter at the moment k+1, and is a ratio of the estimation variance to the total variance (the sum of the estimation variance and the measurement variance); H is a system measurement matrix; R is the covariance of the measurement noise; and Kalman filtering estimates the variable value at a time according to the variation trend of current observation values of the variables, and this gain matrix represents the magnitude of a level of variation. Formula (3) transmits the gain K(k+1) at the moment k+1 to the formulas (4) and (5) for the optimal estimation of the 3D coordinates and optimal covariance estimation at the moment k+1, respectively.

Formula (4) is configured to calculate the optimal estimation values of the 3D coordinates at the moment k+1, wherein W(k+1) is the optimal result of the system state at the moment k+1; S(k+1) represents the system measurement values at the moment k+1; and the formula (4) transmits W(k+1) to the formula (1) to predict the value of the 3D coordinates at the moment k+2.

Formula (5) is configured to calculate a covariance corresponding to the optimal system result at the moment k+1, wherein P(k+1) is a covariance corresponding to the optimal system estimation result at the moment k+1, which is used to correct the variance between the estimated values and the actual values. Formula (5) transmits P(k+1) to formula (2) to predict the value of the error covariance of the 3D coordinates at the moment k+2.

The present disclosure provides a method and apparatus for estimating the 3D coordinates of the bucket tooth tip of the excavator based on Kalman filtering, which is used to generate optimal estimation values of the 3D coordinates of the bucket tooth tip in an engineering machinery coordinate system during construction of an excavator, a loader or other engineering machinery, so as to address the problem of reduced accuracy caused by the measurement noise and system noise in the calculation process of the 3D coordinates of the bucket tooth tip in related technologies, thereby improving the measurement accuracy of the 3D coordinates of the bucket tooth tip and improving the construction quality of the excavator.

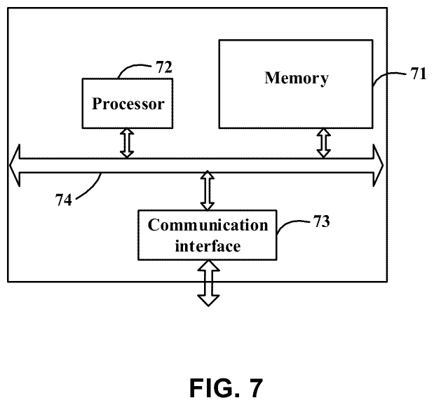

FIG. 7 is a schematic structural diagram of an apparatus for estimating the coordinates of the bucket tooth tip according to other embodiments of the present disclosure. As shown in FIG. 7, the apparatus for bucket tooth tip coordinate estimation of the present disclosure may comprise a memory 71 and a processor 72.

The memory 71 is used to store instructions. The processor 72 is coupled to the memory 71, and is configured to carry out, based on instructions stored in the memory, the method for bucket tooth tip coordinate estimation provided in the above embodiments (any one of the embodiments shown in FIGS. 3, 4 and 6).

As shown in FIG. 7, the apparatus for bucket tooth tip coordinate estimation further comprises an interface 73 for performing information interaction with other devices. In addition, the apparatus for bucket tooth tip coordinate estimation further comprises a bus 74. The processor 72, the communication interface 73 and the memory 71 perform communication with each other through the bus 74.

The memory 71 may comprise a high speed RAM memory, and may also comprise a non-volatile memory such as at least one disk storage device. The memory 71 may also be a memory array. The memory 71 may also be partitioned into blocks, which may be combined into virtual volumes according to a certain rule.

In addition, the processor 72 may be a central processing unit (CPU), or may be an Application Specific Integrated Circuit (ASIC) or one or more integrated circuits configured to implement the embodiments of the present disclosure.

The present disclosure relates to the field of coordinate measurement of key components during engineering construction, in particular to a method and apparatus for estimating the 3D coordinates of the bucket tooth tip of the excavator based on Kalman filtering.

According to a further aspect of the present disclosure, there is provided a system for estimating the coordinates of the bucket tooth tip, comprising excavator dynamic sensors and the apparatus for estimating the coordinates of the bucket tooth tip as described in any of the above embodiments (e.g., the embodiment shown in FIG. 6 or 7).

In some embodiments of the present disclosure, the excavator dynamic sensors comprise at least one of a rotary encoder for measuring a rotation angle of the excavator rotary device, a boom inclinometer for measuring a boom angle, a stick inclinometer for measuring a stick angle and a bucket inclinometer for measuring a bucket angle.

In some embodiments of the present disclosure, the rotary encoder is a rotational encoder.

In some embodiments of the present disclosure, the system for estimating 3D coordinates of the bucket tooth tip based on Kalman filtering adopts rotational encoders and inclinometers for angle measurement, and transmits the data to the apparatus for estimating the coordinates of the bucket tooth tip for processing.

In some embodiments of the present disclosure, the rotational encoder is a AR62/63 heavy-duty absolute encoder or the Heidelberg ERN 1387 2048 62S14-70 rotary encoder.

In some embodiments of the present disclosure, the inclinometer is a BW-VG525 ultra high precision CAN dynamic inclinometer.

In some embodiments of the present disclosure, the apparatus for estimating the bucket tooth tip can be implemented by an industrial control computer.

In some embodiments of the present disclosure, the industrial control computer is a Nuvo-7531 industrial control computer, which comprises a processor and a memory. When the processor is used to execute a computer program stored in the memory, all functions of the method for estimating 3D coordinates of the bucket tooth tip of the excavator based on Kalman filtering as described above are implemented.

In some embodiments of the present disclosure, for the purpose of protecting the sensor, the bucket inclinometer is mounted near a bucket rotation axis.

In some embodiments of the present disclosure, after the installation of the inclinometer, its output voltages and corresponding angle values are actually measured, based on which linear fitting is performed, indicating that the inclinometer has good linearity. The fitting relationship between the output voltage U of the inclinometer and the measured inclination Tis U=−0.0553T+0.0254.

The present disclosure provides a method, apparatus and system for estimating 3D coordinates of the bucket tooth tip of the excavator based on Kalman filtering, which belongs to the technical field of engineering machinery. The technical solution of the present disclosure comprises: establishing a kinematic model of the excavator according to the dimensions of the plurality of components of the excavator, and calculating rotation angles of the boom, stick and bucket of the excavator, as well as 3D coordinates of the bucket tooth tip of the excavator in an excavator coordinate system according to the angles of the plurality of components of the excavator measured by the four dynamic sensors of the excavator with the kinematic model. After measuring and calculating the 3D coordinates of the excavator's bucket tooth tip, in conjunction with prior knowledge such as a measurement error covariance and a system noise covariance in the excavator 3D coordinate measurement system, an optimal estimation of the measured values of the 3D coordinates is performed based on Kalman filtering, thereby significantly improving the measurement accuracy of the 3D coordinates of the bucket tooth tip of the excavator.

The present disclosure is aimed at the existing systems for measuring 3D coordinates of the bucket tooth tip of the excavator, and can output the optimal estimation values of the 3D coordinates in real-time without hardware modification, thereby significantly improving the detection accuracy of the 3D coordinates, and effectively improving the accuracy and construction quality of the excavator.

According to a further aspect of the present disclosure, as shown in FIG. 2, there is provided an excavator, comprising the system for estimating the coordinates of the bucket tooth tip as described in any of the above embodiments.

According to a still another aspect of the present disclosure, there is provided a computer-readable storage medium stored thereon computer instructions that, when executed by a processor, perform the method for estimating the coordinates of the bucket tooth tip as described in any of the above embodiments.

The computer readable storage medium of the present disclosure is a non-transitory computer readable storage medium.

One skilled in the art should understand that, the embodiments of the present disclosure may be provided as a method, an apparatus, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable non-transitory storage media (including but not limited to disk storage, CD-ROM, optical storage device, etc.) having computer-usable program code embodied therein.

The present disclosure is described with reference to flowcharts and/or block diagrams of methods, apparatuses (systems) and computer program products according to embodiments of the present disclosure. It should be understood that each process and/or block in the flowcharts and/or block diagrams, and combinations of the processes and/or blocks in the flowcharts and/or block diagrams may be implemented by computer program instructions. The computer program instructions may be provided to a processor of a general purpose computer, a special purpose computer, an embedded processor, or other programmable data processing apparatus to generate a machine such that the instructions executed by a processor of a computer or other programmable data processing apparatus to generate means implementing the functions specified in one or more flows of the flowcharts and/or one or more blocks of the block diagrams.

The computer program instructions may also be stored in a computer readable storage device capable of directing a computer or other programmable data processing apparatus to operate in a specific manner such that the instructions stored in the computer readable storage device produce an article of manufacture including instruction means implementing the functions specified in one or more flows of the flowcharts and/or one or more blocks of the block diagrams.

These computer program instructions can also be loaded onto a computer or other programmable device to perform a series of operation steps on the computer or other programmable device to generate a computer-implemented process such that the instructions executed on the computer or other programmable device provide steps implementing the functions specified in one or more flows of the flowcharts and/or one or more blocks of the block diagrams.

The apparatus for bucket tooth tip coordinate estimation, the coordinate measurement unit, the noise acquisition unit, the coordinate estimation unit, the 3D coordinate prediction module and the 3D coordinate update module described above may be implemented as a general-purpose processor for performing the functions described in this application, Programmable logic controller (PLC), digital signal processor (DSP), application specific integrated circuit (ASIC), field programmable gate array (FPGA) or other programmable logic devices, discrete gates or transistor logic devices, discrete hardware components or any appropriate combination thereof.

As appreciated by those skilled in the art, all or part of the steps of the method of the disclosed embodiments can be completed by hardware, which can be implemented as a general-purpose processor, a programmable logic controller, a digital signal processor, a specific integrated circuit, a field programmable gate array or other programmable logic devices, discrete gates or transistor logic devices, discrete hardware components or any appropriate combination thereof.

Heretofore, the present disclosure has been described in detail. In order to avoid obscuring the concepts of the present disclosure, some details known in the art are not described. Based on the above description, those skilled in the art can understand how to implement the technical solutions disclosed herein.

A person skilled in the art can understand that all or part of the steps for carrying out the method in the above embodiments can be completed by hardware or a program instructing the related hardware, wherein the program can be stored in a non-transitory computer readable storage medium. The storage medium may be a read-only memory (ROM), a magnetic disk or a compact disk (CD).

The above description of this invention is given for illustration and description, but is not exhaustive and is not intended to limit the present invention to the form disclosed herein. Various modifications and variations are apparent for a person of ordinary skill in the art. Embodiments are selected and described for a better illustration of the principle and practical application of this invention, so that those skilled in the art can understand this invention and envisage various embodiments with various modifications suited to specific usages.

1. A method for estimating coordinates of a bucket tooth tip, comprising:
establishing a kinematic model of an excavator according to dimensions of a plurality of components of the excavator, and obtaining measured values of the coordinates of the bucket tooth tip of the excavator according to angles of the plurality of components of the excavator measured by excavator sensors with the kinematic model;
obtaining a system noise and a measurement noise of the coordinates of the bucket tooth tip of the excavator; and
determining estimated values of the coordinates of the bucket tooth tip of the excavator according to the measured values of the coordinates of the bucket tooth tip of the excavator, the system noise and the measurement noise of the coordinates of the bucket tooth tip of the excavator.

2. The method according to claim 1, wherein the obtaining system noise and a measurement noise in the coordinates of the bucket tooth tip of the excavator comprises:
determining a measurement error covariance in the process of angle measurement and determining a system noise covariance in the process of coordinate calculation of the excavator.

3. The method according to claim 1, wherein the determining the estimated values of the coordinates of the bucket tooth tip of the excavator according to the measured values of the coordinates of the bucket tooth tip of the excavator, the system noise and the measurement noise of the coordinates of the bucket tooth tip of the excavator, comprises:
determining the estimated values of the coordinates of the bucket tooth tip of the excavator by using a predetermined filter to estimate the measured values of the coordinates of the bucket tooth tip of the excavator, according to the measured values of the coordinates of the bucket tooth tip of the excavator, the system noise and the measurement noise of the coordinates of the bucket tooth tip of the excavator.

4. The method according to claim 3, wherein the determining the estimated values of the coordinates of the bucket tooth tip of the excavator by using a predetermined filter to estimate the measured values of the coordinates of the bucket tooth tip of the excavator, according to the measured values of the coordinates of the bucket tooth tip of the excavator, the system noise and the measurement noise of the coordinates of the bucket tooth tip of the excavator, comprises:
obtaining a predicted value of a state vector at a moment k+1 according to the state vector at a moment k, wherein the state vector is a state vector of a system for estimating the coordinates of the bucket tooth tip, and the state vector represents the coordinates of the bucket tooth tip of the excavator at a moment;
obtaining the predicted value of an error covariance matrix at the moment k+1 according to an estimated value of the error covariance matrix at the moment k, wherein the error covariance matrix is configured to represent estimation accuracy of the state vector; and
estimating the state vector and the error covariance matrix at the moment k+1 to obtain estimated values of the state vector and the error covariance matrix at the moment k+1, according to the predicted values of the state vector and the error covariance matrix at the moment k+1, and measured values output by the system at the moment k+1.

5. The method according to claim 4, wherein the determining the estimated values of the coordinates of the bucket tooth tip of the excavator by using a predetermined filter to estimate the measured values of the coordinates of the bucket tooth tip of the excavator, according to the measured values of the coordinates of the bucket tooth tip of the excavator, the system noise and the measurement noise of the coordinates of the bucket tooth tip of the excavator, further comprises:
assigning the estimated values of the state vector and the error covariance matrix at the moment k+1 to the obtaining a predicted value of the state vector at the moment k+1 according to the state vector at the moment k and the obtaining the predicted value of the error covariance matrix at the moment k+1 according to an estimated value of the error covariance matrix at the moment k, to iteratively predict values of the state vector and the error covariance matrix at a next moment.

6. The method according to claim 4, wherein the obtaining a predicted value of the state vector at the moment k+1 according to the state vector at the moment k, comprises:
defining the state vector;
establishing a dynamic model of the system for estimating the coordinates of the bucket tooth tip, wherein the dynamic model is a state transition matrix configured to represent a transformation relationship between the state vector at the moment k and the state vector at the moment k+1; and
obtaining the predicted value of the state vector at the moment k+1 according to the state vector at the moment k and the state transition matrix.

7. The method according to claim 4, wherein the obtaining the predicted value of the error covariance matrix at the moment k+1 according to the estimated value of the error covariance matrix at the moment k, comprises:
defining a covariance matrix of a system process noise; and
obtaining the predicted value of the error covariance matrix at the moment k+1 according to the estimated value of the error covariance matrix at the moment k, the state transition matrix, and the covariance matrix of the system process noise.

8. The method according to claim 4, wherein the estimating the state vector and the error covariance matrix at the moment k+1 to obtain estimated values of the state vector and the error covariance matrix at the moment k+1, according to the predicted values of the state vector and the error covariance matrix at the moment k+1 and measured values output by the system at the moment k+1, comprises:
determining a filter gain value at the moment k+1 according to the predicted value of the error covariance matrix at the moment k+1, a system measurement matrix of the coordinates of the bucket tooth tip and a covariance matrix of the measurement noise;
estimating the state vector at the moment k+1 to obtain the estimated value of the state vector at the moment k+1, according to the predicted value of the state vector at the moment k+1, the filter gain value at the moment k+1 and the measured values of the system output at the moment k+1; and
estimating the error covariance matrix at the moment k+1 to obtain the estimated value of the error covariance matrix at the moment k+1,according to the predicted value of the error covariance matrix at the moment k+1 and the filter gain value at the moment k+1.

9. The method according to claim 8, wherein the determining the filter gain value at the moment k+1 according to the predicted value of the error covariance matrix at the moment k+1, the system measurement matrix of the coordinates of the bucket tooth tip and the covariance matrix of the measurement noise, comprises:
determining an estimation variance according to the predicted value of the error covariance matrix at the moment k+1 and the system measurement matrix of the coordinates of the bucket tooth tip;
determining a total variance according to the estimation variance and the covariance matrix of measurement noise; and
determining the filter gain value at the moment k+1 according to a ratio of the estimation variance to the total variance.

10. The method according to claim 8, wherein the estimating the state vector at the moment k+1 to obtain the estimated value of the state vector at the moment k+1, according to the predicted value of the state vector at the moment k+1, the filter gain value at the moment k+1 and the measured values of the system output at the moment k+1, comprises:
defining a measurement vector of the coordinates of the bucket tooth tip;
establishing a measurement model of the system for estimating coordinates of the bucket tooth tip, wherein the measurement model is used to map the state vector to the measurement vector;
determining a measurement vector value at the moment k+1 according to the predicted value of the state vector at the moment k+1 and the system measurement matrix of the coordinates of the bucket tooth tip; and
estimating the state vector at the moment k+1 to obtain the estimated value of the state vector at the moment k+1, according to the measurement vector value at the moment k+1, the predicted value of the state vector at the moment k+1, the filter gain value at the moment k+1 and the measured value of the system output at the moment k+1.

11. The method according to claim 8, wherein the estimating the error covariance matrix at the moment k+1 to obtain the estimated value of the error covariance matrix at the moment k+1, according to the predicted value of the error covariance matrix at the moment k+1 and the filter gain value at the moment k+1, comprises:
estimating the error covariance matrix at the moment k+1 to obtain the estimated value of the error covariance matrix at the moment k+1, according to the predicted value of the error covariance matrix at the moment k+1, the system measurement matrix of the coordinates of the bucket tooth tip and the filter gain value at the moment k+1.

12. The method according to claim 1, wherein the establishing the kinematic model of the excavator according to the dimensions of the plurality of components of the excavator, comprises:
establishing five coordinate systems at different components of the excavator, wherein the origins of the five coordinate systems are respectively: an intersection of a vertical axis around which a rotary platform of the excavator rotates and the ground, a connection joint between a boom and the rotary platform of the excavator, a connection joint between the boom and a stick of the excavator, a joint between the stick and a bucket of the excavator, and the bucket tooth tip, wherein a coordinate system taking the intersection of the vertical axis around which the rotary platform of the excavator rotates and the ground as the origin is an excavator coordinate system.

13. (canceled)

14. An apparatus for estimating coordinates of a bucket tooth tip, comprising:
a memory configured to store computer instructions; and
a processor configured to execute a method for performing the instructions comprising:
establishing a kinematic model of an excavator according to dimensions of a plurality of components of the excavator, and obtaining measured values of the coordinates of the bucket tooth tip of the excavator according to angles of the plurality of components of the excavator measured by excavator sensors with the kinematic model;
obtaining a system noise and a measurement noise of the coordinates of the bucket tooth tip of the excavator; and
determining estimated values of the coordinates of the bucket tooth tip of the excavator according to the measured values of the coordinates of the bucket tooth tip of the excavator, the system noise and the measurement noise of the coordinates of the bucket tooth tip of the excavator.

15. A system for estimating coordinates of a bucket tooth tip, comprising excavator dynamic sensors and the apparatus according to claim 14.

16. The system according to claim 15, wherein the excavator dynamic sensors comprise at least one of a rotary encoder for measuring a rotation angle of a rotary platform of the excavator, a boom inclinometer for measuring a boom angle, a stick inclinometer for measuring a stick angle, and a bucket inclinometer for measuring a bucket angle.

17. An excavator, comprising the system according to claim 15.

18. A non-transitory computer-readable storage medium stored thereon computer instructions that, when executed by a processor, implement a method comprising:
establishing a kinematic model of an excavator according to dimensions of a plurality of components of the excavator, and obtaining measured values of the coordinates of the bucket tooth tip of the excavator according to angles of the plurality of components of the excavator measured by excavator sensors with the kinematic model;
obtaining a system noise and a measurement noise of the coordinates of the bucket tooth tip of the excavator; and
determining estimated values of the coordinates of the bucket tooth tip of the excavator according to the measured values of the coordinates of the bucket tooth tip of the excavator, the system noise and the measurement noise of the coordinates of the bucket tooth tip of the excavator.

19. (canceled)

20. The apparatus according to claim 14, wherein the obtaining system noise and a measurement noise in the coordinates of the bucket tooth tip of the excavator comprises:
determining a measurement error covariance in the process of angle measurement and determining a system noise covariance in the process of coordinate calculation of the excavator.

21. The apparatus according to claim 14, wherein the determining the estimated values of the coordinates of the bucket tooth tip of the excavator according to the measured values of the coordinates of the bucket tooth tip of the excavator, the system noise and the measurement noise of the coordinates of the bucket tooth tip of the excavator, comprises:
determining the estimated values of the coordinates of the bucket tooth tip of the excavator by using a predetermined filter to estimate the measured values of the coordinates of the bucket tooth tip of the excavator, according to the measured values of the coordinates of the bucket tooth tip of the excavator, the system noise and the measurement noise of the coordinates of the bucket tooth tip of the excavator.

22. The apparatus according to claim 21, wherein the determining the estimated values of the coordinates of the bucket tooth tip of the excavator by using a predetermined filter to estimate the measured values of the coordinates of the bucket tooth tip of the excavator, according to the measured values of the coordinates of the bucket tooth tip of the excavator, the system noise and the measurement noise of the coordinates of the bucket tooth tip of the excavator, comprises:
obtaining a predicted value of a state vector at a moment k+1 according to the state vector at a moment k, wherein the state vector is a state vector of a system for estimating the coordinates of the bucket tooth tip, and the state vector represents the coordinates of the bucket tooth tip of the excavator at a moment;
obtaining the predicted value of an error covariance matrix at the moment k+1 according to an estimated value of the error covariance matrix at the moment k, wherein the error covariance matrix is configured to represent estimation accuracy of the state vector; and
estimating the state vector and the error covariance matrix at the moment k+1 to obtain estimated values of the state vector and the error covariance matrix at the moment k+1, according to the predicted values of the state vector and the error covariance matrix at the moment k+1, and measured values output by the system at the moment k+1.
